(19) United States
(12) Patent Application Publication
(10) Pub. No.: US 2026/0035489 A1
(43) Pub. Date: Feb. 5, 2026

(54) RADIATION CURABLE COMPOSITION FOR COMPOSITE MATERIAL

(71) Applicant: ALLNEX BELGIUM S.A., Drogenbos (BE)

(72) Inventors: Paul GEVAERT, Geraardsbergen (BE); Steven CAPPELLE, Ninove (BE); Luc BOOGAERTS, Herent (BE); Carmen VAN VAERENBERGH, Sint Katherina Lombeek (BE)

(73) Assignee: ALLNEX BELGIUM S.A., Drogenbos (BE)

(21) Appl. No.: 18/881,861

(22) PCT Filed: Feb. 7, 2023
(86) PCT No.: PCT/EP2023/052961

§ 371 Date: Jan. 7, 2025

(30) Foreign Application Priority Data
Jul. 11, 2022 (EP) 22184020.0

(51) Int. Cl. C08F 2/48; C08F 2/44; C08F 222/10; C08F 290/06; C08G 63/16; C08K 3/04; C08K 7/14

(52) U.S. Cl. CPC C08F 2/48; C08F 2/44; C08F 222/103; C08F 222/1065; C08F 290/067; C08G 63/16; C08K 3/041; C08K 7/14; C08K 2201/001; C08K 2201/011

(57) ABSTRACT

An actinic radiation and/or thermally curable composition (I) for composite material comprising: (A) at least 20 wt % of compound A comprising at least 2 ethylenically unsaturated moieties and a structural moiety; (B) at least 20 wt % of compound B comprising at least 2 ethylenically unsaturated moieties and a cycloaliphatic structure or heterocyclic aliphatic structure; (C) from 1 to 40 wt % of a compound C different from compound A and B containing essentially one ethylenically unsaturated moiety and having a viscosity of less than 100 mPa·s measured at 25° C., preferably below 50 mPa·s. even more preferably below 25 mPa·s; and (D) from 0 to 20 wt % of a compound D, comprising at least one ethylenically unsaturated moiety, and which is different from compound A, B and C; whereby the total of compound B and A have a content of from 60 to 99 wt % in view of the total content of compounds A. B, C and optionally D.

The present invention relates to the field of actinic radiation and/or thermally curable compositions for composite material, composite material comprising such composition and filler material, and a method for coating the filler material.

### BACKGROUND OF THE INVENTION

A composite or a composite material is a combination of two or more non miscible materials typically comprising a plastic or resin matrix and a filler material whereby the resin holds the filler together and forms a continuous phase for cohesion of the structure and the filler material. Composites can have various shapes and mechanical properties depending on the application. The applications are numerous and it can be used e.g. in automotive, aerospace, transport, building, electronics. Composite materials are often used to make pipes, such as geothermal pipes, but also pipes for offshore and onshore applications.

State-of-the-art composite manufacturing techniques are often not cost effective due to the long curing via heating and cooling cycle times. This prevents their use in high volume applications. The use of radiation curing in composite manufacturing can significantly reduce this cycle time since curing takes place very quickly and at low temperature. This makes it suitable for high volume production of composite materials. There are UV light curable compositions developed that are able to form the resin matrix for the filler material. UV-light has the advantage that the curing is very fast, which enhance the manufacturing process significantly.

UV light curable compositions are described in WO2014/191308 A1, where the composite compositions comprise a resin containing isosorbide diacrylate. This type of compositions have as drawback that they provide composites that are rather stiff once cured.

Many of the applications require composite material having certain degree of flexibility, while at the same time they still must withstand a certain amount of stress and have a certain amount of toughness. A good balance between these properties are difficult to obtain.

### SUMMARY OF THE INVENTION

Inventors have now surprisingly found a composition that overcomes, at least partially, the above mentioned problems by providing an actinic radiation and/or thermally curable composition (I) as described in claim 1. Accordingly, the first aspect of the invention is related to an actinic radiation and/or thermally curable composition (I) for composite material comprising:
(A) at least 20 wt % of compound A comprising at least 2 ethylenically unsaturated moieties and a structural moiety selected from the group consisting of polyalkylene glycol such as polyethylene glycol; polypropylene glycol; polycaprolactone; polybutadiene or a hydrogenated or partially hydrogenated form thereof; polyisoprene or the hydrogenated or the partially hydrogenated form thereof; polyester derivable from a polyol and a dicarboxylic acid;
(B) at least 20 wt % of compound B comprising at least 2 ethylenically unsaturated moieties and a cycloaliphatic structure or heterocyclic aliphatic structure;
(C) from 1 to 40 wt % of a compound C different from compound A and B containing essentially one ethylenically unsaturated moiety having a viscosity of less than 100 mPa·s measured at 25° C., preferably below 50 mPa·s, even more preferably below 25 mPa·s;
(D) from 0 to 20 wt % of a compound D containing at least one ethylenically unsaturated moiety different from compound A, B and C;
   whereby the total of compound B and A have a content of from 60 to 99 wt % in view of the total content of compound A, B, C and optionally D; and
   wherein composition (I) has after curing a glass transition temperature (Tg) of at least 90° C. according to the standard test method ASTM E1640 using dynamic mechanical analysis.

It is found that such composition can be used for composite materials and have one or more of the following advantages:
they may be suitable for high volume applications at a high speed production
they may be used to form a large variety of composite articles
they may be suitable for obtaining composite articles while experiencing little shrinkage upon curing, thereby preventing warpage and/or poor part fitting
they may have a low toxicity;
they may be free of bisphenol A;
they may be free of styrene;
the composition (I) may be of low viscosity, facilitating its use in a liquid composite manufacturing process;
composition (I) may have a good pot life even at room temperature;
the storing costs of the composition (I) may be low.

In addition it is found that such compositions provide after actinic radiation and/or thermally curing a composite material that has some flexibility with still a high thermal resistance, meaning that the compositions provide a coating with a sufficiently high glass transition temperature and good elongation properties and which can endure a high ultimate flexural strain. Compositions having a high Tg are usually hard and brittle. It is surprisingly found that the composition of current invention can be flexible after curing while still having a high Tg. In some cases they even provide a good brine resistance.

Accordingly, present invention is also related to a second aspect, a composite material comprising the curable composition (I) of the first aspect and a filler material (II).

In a third aspect, present invention is related to a process of making a composite material comprising the steps of:
contacting filler material with the curable composition (I) of the first aspect;
curing the curable composition (I) contacted with the filler material.

This may present one or more of the following advantages:
It may be fast;
It may be performed at low temperature;
It may be performed on demand, thereby facilitating handling in industrial production;
It may be cost effective;
It may be used in high volume applications;
It may require a low energy consumption in part due to the absence of need for heating;

### DETAILED DESCRIPTION OF THE INVENTION

The first aspect relates to an actinic radiation and/or thermally curable composition (I) for composite material comprising:
(A) at least 20 wt % of compound A comprising at least 2 ethylenically unsaturated moieties and a structural moiety selected from the group consisting of polyalkylene glycol; polycaprolactone; polybutadiene or a hydrogenated or partially hydrogenated form thereof; polyisoprene or the hydrogenated or the partially hydrogenated form thereof; polyester derivable from a polyol and a dicarboxylic acid;
(B) at least 20 wt % of compound B comprising at least 2 ethylenically unsaturated moieties and a cycloaliphatic structure or heterocyclic aliphatic structure;
(C) from 1 to 40 wt % of a compound C different from compound A and B containing essentially one ethylenically unsaturated moiety and having a viscosity of less than 100 mPa·s measured at 25° C., preferably below 50 mPa·s, even more preferably below 25 mPa·s;
(D) from 0 to 20 wt % of a compound D comprising at least one ethylenically unsaturated moiety, different from compound A, B and C;
   whereby the total of compound B and A have a content of from 60 to 99 wt % in view of the total content of compound A, B, C and optionally D; and
   wherein composition (I) has after curing a glass transition temperature (Tg) of at least 90° C. according to the standard test method ASTM E1640 using dynamic mechanical analysis.

It has been found that such composition provides after curing a material with an ultimate tensile elongation of more than 3%, preferably more than 5% whereby the tensile elongation is measured according to the standard test method ASTM D638 determining the uniaxial stress-strain (tensile) properties. Such composition is suitable for composite material requiring a certain amount of formability such as for (spoolable) pipes, (printing) sleeves and windmill blades. The composition (I) according to the first aspect can also be used for repairing an article made of a composite material.

The composition (I) has a glass transition temperature of not lower than 90° C., preferably not lower that 100° C., after curing, whereby the Tg is measured according to the standard test method ASTM E1640 using dynamic mechanical analysis.

It is also found that such composition provides after curing a material with very high flexural bending properties and has an ultimate flexural strain of more than 5%, preferably more than 6%, as measured according to the standard test method ASTM D790 whereby a three point bending test is performed.

Accordingly, in one embodiment, the curable composition (I) has an ultimate tensile elongation of more than 3% and an ultimate flexural strain of more than 5%.

As used herein, “ethylenically unsaturated moiety” refers to a moiety comprising a polymerizable ethylenically unsaturated group. By polymerizable ethylenically unsaturated group is meant a carbon-carbon double bond which under influence of an initiator and/or irradiation, eventually in the presence of a photoinitiator, can undergo radical polymerization. The polymerizable ethylenically unsaturated groups are generally chosen from (meth)acrylic groups. In the present invention, the term “(meth)acrylic” is to be understood as to encompass both acrylic and methacrylic groups present on compounds either separately or as mixtures thereof.

As used herein “actinic radiation curable composition” refers to a composition that can, at least partially, be cured by electromagnetic radiation such as near infrared, visible light, UV light, or X-rays, in particular UV light, or corpuscular radiation such as an electron beam. Actinic radiation can occur in the presence of a photoinitiator (system). Preferably, the composition of the first aspect is fully cured after exposure to actinic radiation.

As used herein, “composite material” refers to a composite material consisting of a plastic or resin matrix whereby the resin matrix holds a reinforcement constituent. The reinforcement constituent in the composite material will increase the composite's stiffness and tensile strength.

With UV light radiation is meant irradiation via a ultraviolet light source including high or low-pressure mercury lamps, cold cathode tubes, xenon lamps, black lights, ultraviolet lasers, and a flash lights, and LED light sources. Typically the wavelength of a UV light source is between 240 and 405 nm.

With radiation using LED light sources is meant irradiation via a light-emitting diode source, whereby a semiconductor light source is used. Typically a wavelength of 365, 385, 395 or 405 nm is used.

As used herein “thermally curable composition” is a composition that can be cured via polymerization initiated by free-radical generating agents, including peroxide and azo-type initiators. Peroxide initiators include diacylperoxides, hydroperoxides, ketone peroxides, peroxyesters, peroxyketals, dialkyl peroxides, alkyl peresters and percarbonates and the like, used alone or with redox systems. Examples of these peroxides include methyl ethyl ketone peroxide (MEKP), methyl isobutyl ketone peroxide (MIBK), benzoyl peroxide (BPO) and cumene hydroperoxide (CHP). Combinations of two or more peroxides may be used to cure the resin. Azo-type initiators include azobisisobutyronitrile (AIBN) and related compounds.

The free radical reaction can be accelerated by the use of metal carboxylates, such as cobalt napthenate and cobalt octoates. Zinc, iron, vanadium, potassium and other metal complexes may also be used for this process. Nitrogen-containing compounds, such as derivatives of aniline, various amides, aromatic and aliphatic amines, may be used to enhance the cure. In absence of such accelerator, the curing can occur by heating to a temperature such as higher than 60° C. When accelerators are present, curing can occur at room temperature (i.e. around 20° C.) or by heating at a higher temperature such as 30° C. or more.

With “for composite material” is meant “suitable for composite material”.

Compound A comprises at least 2 ethylenically unsaturated moieties and a structural moiety selected from the group consisting of polyalkylene glycol; polycaprolactone; polybutadiene or a hydrogenated or partially hydrogenated form thereof; polyisoprene or the hydrogenated or the partially hydrogenated form thereof; or a polyester derivable from a polyol and a dicarboxylic acid.

In one embodiment, the structural moiety derives from compounds having a Tg that is below 0° C., preferably below −20° C., more preferably below −30° C., even more preferably below-40° C.

Preferably, the Tg of Compound A, when homopolymerized, is more than 0° C., more preferably more than 10° C., even more preferably more than 30° C. Preferably, the Tg is lower than 80° C.

In one embodiment, the polyester structural moiety is derivable from
a condensation reaction of a straight chain aliphatic dicarboxylic acid having 4 to 14 carbon atoms and an aliphatic or cycloaliphatic polyol, preferably an aliphatic diol or cycloaliphatic diol;
a condensation reaction of a dimerized fatty acids compound with an aliphatic or cycloaliphatic diol; or
a condensation reaction of a dimerized fatty alcohols compound with an aliphatic diacid compound.

The polyalkylene glycol moiety preferably has the structure —((CH2)nO)x- or —(CH2CH(CH3)O)x—; whereby n is an integer from 2 to 5 and x is an integer from 5 to 20. Preferred examples are moieties of polyethylene glycol (Tg of about −67° C.), biobased polypropane diol (also called poly(trimethylene glycol) or poly(1,3 propane diol) (Tg of about −77° C.); polypropylene glycol (Tg of about −74° C.); poly-tetrahydrofuran (also called poly-tetramethyleneoxide), (Tg of about −86° C.);

The polycaprolactone moiety preferably has the structure —(C(C=O)(CH2)uO)t-; whereby u is an integer from 3 to 5 and t is an integer from 4 to 20. Typically the moiety derives from polycaprolactone having a Tg of about −66° C.

The polybutadiene moiety preferably has the structure —(CH2-CH(CH═CH2)p-(CH2-CH═CH—CH2)q-; whereby the sum of p and q is an integer from 10 to 100 and whereby p≥0 and q≥0; or a hydrogenated or partially hydrogenated form thereof. Preferred examples are moieties of poly(1,2-butadiene) (Tg of about −13° C.) and poly(1,4-butadiene) (Tg of about −105° C.)

The polyisoprene moiety preferably has the structure —(CH2-C(CH3)═CH—CH2)r-, whereby r is an integer from 10 to 100, or a hydrogenated or partially hydrogenated form thereof;

The polyester moiety preferably has the structure —(O(C═O)—R′—(C═O)O—R″—)n-.
whereby R′ is a saturated straight chain alkyl having 2 to 14 carbon atoms and R″ is a saturated aliphatic or cycloaliphatic alkyl; and whereby n is an integer from 3 to 20;
whereby R′ is a dimerized fatty acid residue; R″ is a saturated aliphatic or cycloaliphatic alkyl; and whereby n is an integer from 3 to 20;
whereby R′ is an aliphatic diacid residue; R″ is a dimerized fatty diol residue; and whereby n is an integer from 3 to 20.

Examples polyesters moieties whereby R′ is a saturated straight chain alkyl having 4 to 14 carbon atoms and R″ is a saturated aliphatic or cycloaliphatic alkyl, are moieties derived from poly(ethylene adipate) (Tg of about −44° C.), poly(l,4-butylene adipate) (Tg of about −68° C.).

Examples of polyester moieties whereby R′ is a dimerized fatty acid residue; R″ is a saturated aliphatic or cycloaliphatic alkyl; and whereby n is an integer from 3 to 20; or whereby R′ is an aliphatic diacid residue; R″ is a dimerized fatty diol residue; and whereby n is an integer from 3 to 20 are the polyesters from the Pripol™ or Priplast™ range commercially available at Croda.

Compound A is present in an amount of at least 20 wt % in view of the total amount of the composition (I) comprising compound A, B, C and optionally compound D.

Preferably, compound A comprises at least 2 (meth)acrylate groups and at most 8, more preferably at most 6 (meth)acrylate groups.

In one embodiment, the weight average molecular weight of the structural moiety is between 200 and 10000, more preferably between 400 and 5000.

In a preferred embodiment, compound A is polyester di- or tri-(meth)acrylate or polyurethane di- or tri-(meth)acrylate; whereby the polyester (meth)acrylate is a reaction product of (meth)acrylic acid with a polyol comprising a structural moiety as defined above; and whereby the polyurethane (meth)acrylate is a reaction product of a mono- or poly-hydroxy (meth)acrylate, a mono- or poly-isocyanate and a compound comprising a structural moiety as defined above. A person skilled in the art is able to prepare such type of polyesters or polyurethanes.

Preferred examples of compound A are di or tri(meth)acrylate compounds comprising a structural moiety based on poly(tetramethyleneoxide), poly(propyleneoxide), poly(ethyleneoxide) moiety, a polyester moiety formed as a condensation reaction product of a C4-C20 straight chain alkyl diacid with an aliphatic or cycloaliphatic diol compound, a polyester moiety formed by the condensation reaction of a dimerized fatty acid with an aliphatic or cycloaliphatic diol or a polyester moiety formed by the condensation reaction of a dimer fatty diol with an aliphatic diacid compound.

Examples of such compounds include urethane di or tri(meth)acrylate compounds or polyester di or tri(meth)acrylate compounds comprising these structural moieties.

Compound B comprises at least 2 ethylenically unsaturated moieties, preferably (meth)acrylate groups, and a cycloaliphatic structure or a heterocyclic aliphatic structure.

In one preferred embodiment, compound B does not comprise the structural moiety of compound A.

Compound B comprises at least two ethylenically unsaturated moieties and preferably not more than 8, more preferably not more than 6 ethylenically unsaturated moieties.

Compound B has further a cyclic structure which is a cycloaliphatic structure of a heterocyclic aliphatic structure. The structure can also be polycyclic. With “cycloaliphatic structure” is meant an aliphatic hydrocarbon that contains at least one ring structure. With “heterocyclic aliphatic structure” is meant a cyclic structure whereby the cyclic structure has atoms of at least two different elements as members of its ring(s). The atoms are preferably carbon, amine, oxygen, and/or sulfur. The ethylenically unsaturated moieties of compound B may be attached to the cyclic structures, or there may be a linker between the ethylenically unsaturated moieties and the cyclic structure(s). The cyclic structure(s) may have further functional groups. Compound B does not comprise an aromatic ring structure.

Preferred examples of a compound B is tricyclodecane dimethanol di(meth)acrylate, cyclohexane dimethanol di(meth)acrylate, hydrogenated bisphenol A di(meth)acrylate, isosorbide based poly(meth)acrylates, such as isosorbide di(meth)acrylate, Tris(2-hydroxy ethyl) isocyanurate tri(meth)acrylate.

Composition (I) comprises at least 20 wt % of compound A, and preferably from 20 wt % to 79 wt %, more preferably from 20 wt % to 40 wt % of compound A.

Composition (I) comprises at least 20 wt % of compound B, and preferably from 20 wt % to 79 wt %, more preferably from 20 wt % to 50 wt % of compound B.

The total of compound B and A have a content of from 60 to 99 wt % in view of the total content of compound A, B, C and optionally D.

Composition (I) further comprises from 1 to 40 wt % of compound C different from compound A and B containing essentially one ethylenically unsaturated moiety and having a viscosity of less than 100 mPa·s measured at 25° C., preferably below 50 mPa·s, even more preferably below 25 mPa·s.

Preferably the essentially one ethylenically unsaturated moiety is as (meth)acrylate functional group. Preferably, compound C is added to composition (I), in an amount such that the viscosity of composition (1) is equal or less than 2500, preferably less than 1800, more preferably less than 1500, preferably less than 1000 mPa·s when measured at 25° C. The viscosity is preferably above 100 mPa·s, more preferably above 200 mPa·s when measured at 25° C. Low viscosity facilitates contacting the filler material. The application temperature, i.e. the temperature at which the composition (I) is brought in contact with filler material to obtain a composite can be at room temperature, but also at higher temperatures.

Accordingly, in one embodiment, the curable composition (I) has a viscosity of equal or less than 2500, preferably less than 1800, more preferably less than 1500 mPa·s when measured at 25° C.

Mono(meth)acrylate functional compounds (C) having a low viscosity are well known in the art. They comprise essentially one radiation curable (meth)acrylate group.

Mono(meth)acrylate functional compounds (C) are monofunctional (meth)acrylate monomers. Preferably, the (meth)acrylate functional monomer compound C used have a number average molecular weight (Mn) in the average range of from 100 to 1000 Daltons, more preferably 120 to 800 Daltons and most preferably 120-to 500 Daltons. Typically, the weight average molecular weight (MW) is at most 1000 Daltons.

Preferably, the Tg of the mono(meth)acrylate functional compounds (C), when homopolymerized is preferably at least 40° C., more preferably more than 50° C., and even more preferably more than 60° C.

Examples of suitable mono (meth)acrylate functional monomer are alkyl (meth)acrylates represented by a formula CH2=C(R1)COOCzH2z+1, wherein R1 is a hydrogen atom or a methyl group, and z is 1, wherein CzH2z+1 may have a straight chain structure or a branched chain structure. Suitable examples of suitable mono(meth)acrylate functional monomers include but are not limited to: beta-carboxyethyl(meth)acrylate, methyl(meth)acrylate, ethyl(meth)acrylate, propyl(meth)acryalte, n-butyl(meth)acrylate, i-butyl (meth)acrylate, t-butyl (meth)acrylate, pentyl (meth)acrylate, hexyl (meth)acrylate, heptyl (meth)acrylate, octyl (meth)acrylate, octyl-decyl (meth)acrylate, lauryl (meth)acrylate, cyclohexyl(meth)acrylate, phenoxyethyl (meth)acrylate, phenoxytetraethylene glycol (meth)acrylate, phenoxyhexaethylene glycol (meth)acrylate, phenoxy (meth)acrylate, 2-ethyl hexyl (meth)acrylate, Isopropylideneglycerol (meth)acrylate, isobornyl(meth)acrylate (IBO(M)A), 2-hydroxyethyl(meth)acrylate, hydroxypropyl(meth)acrylate, 4-hydroxybutyl(meth)acrylate, isobornyl (meth)acrylate, (meth)acryloyl morpholine, phenylglycidyl ether (meth)acrylate, cyclic trimethylolpropane formal (meth)acrylate, cyclopentyl (meth)acrylate, cyclohexyl (meth)acrylate, dicyclopentenyl (meth)acrylate, n-butyl acryloyloxy ethyl carbamate, glycerol (meth)acrylate, glycidyl (meth)acrylate, tetrahydrofurfuryl (meth)acrylate, the reaction products of (meth)acrylic acid with the glycidyl ester of aliphatic carboxylic acids such as neodecanoic acid and their mixtures; styrene; norbornyl (meth)acrylate; dicyclopentadienyl (meth)acrylate, hydroxyethyl (meth)acrylate, hydroxypropyl (meth)acrylate, hydroxybutyl (meth)acrylate, allyl (meth)acrylate, benzyl (meth)acrylate, glycidyl (meth)acrylate, phenoxydiethylene glycol (meth)acrylate.

Preferably, monomers can also be biobased. Compounds like IBO(M)A can be also partially biobased compounds thereby increasing the biobased content of the reacted product.

Preferably, no styrene is used because it is considered hazardous compound.

Composition (I) may optionally comprise from 0 to 20 wt % of a compound D comprising at least one ethylenically unsaturated moiety which compound is different from compound A, B and C. Compound D is preferably a (meth)acrylate functional compound. Examples of such compound can vary widely and include a variety of backbone structures in addition to the radiation curable moiety, such as but not limited to urethane, epoxy, polyester, polyether or acrylic functionality. For instance, the compound D may be selected from polyester (meth)acrylates oligomers, urethane (meth)acrylates oligomers, alkoxylated (meth)acrylated oligomers, epoxy (meth)acrylates oligomers, aminated (meth)acrylates oligomers, (meth)acrylated (meth)acrylics oligomers, (meth)acrylic (co)polymers oligomers or a combination thereof.

Composition (I) has a Tg which is at least 90° C. The type and the concentration of compounds A, B, C and optionally D according to the invention are selected in a way that the Tg of the composition (I) is at least 90° C.

Especially when selecting the Tg of compound C and/or D, it is important that the Tg of their polymerized forms and the concentration of these compounds should be taken into account so that the Tg of the composition (I) is at least 90° C. A person skilled in the art is able to select compounds and the concentration so that the composition has the Tg of at least 90° and maintains the good properties such as a targeted viscosity. The targeted viscosity is preferably not too high at the temperature at which the composition is applied. Preferably the Tg of Compound D, when homopolymerized, is at least 20° C., more preferably more than 30° C., and even more preferably more than 50° C. Compound D may have a Tg that is lower, but in that case it is preferred to use a lower concentration.

In embodiments, the composition may comprise a photoinitiator. The curing of the composition can be performed with or without the use of photoinitiators. Typically, the compositions of the invention comprise at least one photoinitiator. Any photoinitiator or mixtures thereof capable of generating free radicals when exposed to radiation may be used. Preferred photoinitiators include IRGACURE™ 184; acyl phosphine oxides, for example IRGACURE™ 819; benziketals such as IRGACURE™ 651, available from BASF; benzophenones such as ADDITOL® BP available from allnex, IRGACURE™ 1173, and IRGACURE™ BP available from BASF or Speedcure photoiniators from Lambson Ltd.

When present, the amount of photoinitiators in the composition of the second aspect is typically from 0.01 to 10 wt %, preferably from 0.1 to 8 wt %, more preferably from 0.1 to 5 wt % relative to the total weight of the composition.

In other embodiments the composition comprises a free-radical generating agent. Preferably, the free-radical generating agent is present in an amount of from 0.01 to 5 wt %, preferably from 0.1 to 4 wt %, more preferably from 0.2 to 3 wt % in view of the total weight of the curably composition (I). Examples of free-radical generating agents are peroxide and azo-type initiators. Peroxide initiators include diacylperoxides, hydroperoxides, ketone peroxides, peroxyesters, peroxyketals, dialkyl peroxides, alkyl peresters and percarbonates and the like, used alone or with redox systems. Examples of these peroxides include methyl ethyl ketone peroxide (MEKP), methyl isobutyl ketone peroxide (MIBK), benzoyl peroxide (BPO) and cumene hydroperoxide (CHP). Combinations of two or more peroxides may be used to cure the resin. Azo-type initiators include azobisisobutyronitrile (AIBN) and related compounds.

The composition usually comprises inhibitors. Examples of suitable inhibitors include but are not limited to phenolic inhibitors such as hydroquinone (HQ), methyl hydroquinone (THQ), tert-butyl hydroquinone (TBHQ), parabenzoquinone (BQ), 4-tert butyl catechol, di-tert-butyl hydroquinone (DTBHQ), hydroquinone monomethyl ether (MEHQ), 2,6-di-tert-butyl-4-methylphenol (BHT) and the like. They may also include phosphines, like triphenylphosphine (TPP) and other materials such as tris-nonylphenylphosphite (TNPP), phenothiazine (PTZ), and triphenyl antimony (TPS). When present, inhibitors are preferably present in an amount up to 0.5 wt %, in particular from 0.0001 to 0.2 wt %, and preferably from 0.01 to 0.1 wt % of the composition.

Photostabilizers can be classified as UV absorbers (UVAs), deactivators (quenchers), hydroperoxide decomposers, and radical scavengers known as hindered amine light stabilizers (HALS).

In embodiments, the composition may further comprise a UV absorber and/or a hindered amine light stabilizer. The UVAs protect the polymers by absorbing destructive UV radiation, while the HALS material protects by reacting with the free radicals that occur after a high-energy UV photon breaks a chemical bond in a polymer.

Examples of UVAs are benzotriazoles such as Tinuvin® 328, Tinuvin® 1130, Tinuvin® 900, Tinuvin® 99-2, and Tinuvin® 384-2, triazines such as Tinuvin® 400, Tinuvin® 405, Tinuvin® 460, Tinuvin® 477, and Tinuvin® 479, and benzophenones such as Tinuvin® 531.

Examples of HALS are Tinuvin® 123, Tinuvin® 144, and Tinuvin® 292, 2,2,6,6-tetramethylpiperidine and 2,6-di-tert-butylpiperidine.

Photostabilizers, when present, may be used in an amount of from 0.1 to 5.0, preferably from 0.5 to 2.5 wt % of the composition.

The composition may comprise further additives such as fiber wetting agents e.g. functionalized silanes; and (acidic) adhesion promotors.

In a second aspect, the invention is related to a composite material comprising the actinic radiation and/or thermally curable composition according to the first aspect of the invention and a filler material (II).

In one embodiment, the composite material comprises varying amounts of filler material (II), e.g., up to 95, 90, 80, 70, 60 weight percent filler material in view of the total composite material. Suitable filler material includes glass fibers, carbon fibers (including graphite fibers), synthetic polymer fibers (e.g., polyester fibers, polyaramid fibers, polyamide fibers), inorganic fibers (e,g., boron fibers), metal fibers (e.g., steel fibers), carbon nanotubes, mineral nanotubes and the like. Composites based on carbon fibers and polyaramid fibers are typically thermally cured.

In a third aspect, present invention is related to a process of making a composite material comprising the steps of:
contacting filler material with the curable composition (I) of the first aspect;
curing the curable composition (I) contacted with the filler material.

The composite material according to the invention can be used for filament winding, with or without the presence of a liner, pultrusion, pull winding, mandrel wrapping, wet layup or resin transfer moulding, vacuum bagging, vacuum infusion, resin infusion and the like.

The curable composition (I) can also be used for making conductive sleeves, such as glass fiber reinforced electrically conductive printing sleeves. In this case the radiation curable composition (I) may be contacted with electrically conductive nanoparticles, such as carbon nanotubes, before or during contacting with the filler material (II).

The present invention is illustrated by the following, non-limiting examples.

### EXAMPLES

Following examples will illustrate the aspects and embodiments of the present invention.

Throughout the invention and in particular in the examples the following measuring methods have been applied:

Viscosity: Cone & plate viscosity at a given temperature, usually 25° C., and a given rotation speed of the spindle, also referred to as shear rate.

Glass transition temperature (Tg) from DMA (ASTM E1640): The glass transition temperature (Tg) was determined using dynamic mechanical thermal analysis (DMTA, instrument DMA800 from TA Instruments) in three-point bending mode. The span between the supporting points was 20 mm and small beam-shaped samples of suitable dimensions (30 mm×5 mm×1.6 mm) were supplied for analysis.

The frequency of the oscillatory deformation was 1 Hz and the amplitude was typically 50 μm. The heating rate was 3° C. min−1. The glass transition temperature (Tg) is reported as the temperature at the maximum of the loss factor (T_{g}=T(tan δₘₐₓ)).

Tensile properties: Ultimate elongation The ultimate elongation was tested according to ASTM D638—using a Zwick Z010 elongation testing machine fitted with a 500N load cell. Dumbbell-shaped samples with a thickness of 1.7 mm and a width of 3 mm were used as test specimens. The nominal clamping distance was 30 mm. Tests were conducted at 23° C. with a cross-head speed of 50 mm/min.

Flexural modulus, strength and strain—three point bending test (ASTM D790): The flexural properties are reported at 23° C. and 30% RH, as determined following a three point bending test using a Universal Testing Machine Z10 (Zwick) fitted with a load cell of 500N. The span between the supports of the bending fixture is 40 mm and samples of suitable dimensions (i.e. 80 mm×20 mm×2 mm) were used for tests. The load was applied at the center of the sample under a steady cross-head speed of 2 mm min−1. The ultimate flexural strength and strain are reported at failure.
Calculation of the flexural strain ϵf=6Dd/L²
   where L=Support span, (mm), d=Depth or thickness of tested beam, (mm) and D=maximum deflection of the center of the beam, (mm)

Hot water/Brine resistance: The glass transition temperature (Tg) and flexural properties are measured respectively after 10 days at 23° C. and 30% relative humidity (RH) and after 10 days in a 28% NaCl solution at 80° C. The lower the difference (expressed in %), the better the brine resistance.

### Material

TABLE 1
Compounds used for making actinic radiation curable compositions.

| | Compound name |
|---|---|
| Poly (tetramethyleneoxide) - based urethane diacrylate | Struct 1 |
| Poly (propyleneoxide) - based urethane triacrylate | Struct 2 |
| Poly(propylene oxide) based urethane diacrylate | Struct 3 |
| Urethane diacrylate oligomer comprising | Struct 4 |
| polytetramethylene oxide diol of about 650 MW | |
| (Ebecryl 8811) | |
| Isosorbide diacrylate (polycyclic heteroaliphatic) | Cycl 1 |
| THEICTA (Tris(2-hydroxy ethyl) isocyanurate triacrylate) | Cycl 2 |
| (monocyclic heteroaliphatic triacrylate) | |
| Ebecryl 130 (tricyclodecane dimethanol diacrylate) | Cycl 3 |
| Isobornyl mono acrylate (cyclic aliphatic) (IBOA) | Compound C |
| HPMA (2-HPMA)(2-Hydroxypropyl Methacrylate) | Compound C |
| HEMA (Hydroxyethyl methacrylate) | Compound C |
| Isobornylmethacrylate IBOMA | Compound C |
| 2-ethyl hexyl methacrylate EHMA | Compound C |
| Ebecryl 3300, (cyclic aromatic based acrylate) | Comparative Cycl 5 |
| Ebecryl 611 (cyclic aromatic based (meth)acrylate) | Comparative Cycl 6 |
| Ebecryl 600 (cyclic aromatic based acrylate) | Comparative Cycl 7 |
| EBECRYL 4858 (bifunctional aliphatic urethane acrylate | Comparative UA |
| available from Allnex) | |
| TMPTA (trimethylolpropane triacrylate) | Comparative Monomer |
| DPGDA (Dipropylene Glycol Diacrylate) | Comparative Monomer |
| BAPO | Photoinitiator |
| ADDITOL ® MBF | Photoinitiator |

TABLE 2
UV curable comparable compositions (Com) and compositions according to the invention (EX)

| | Com | Com | Com | Com | Com | | | | | | | | | EX | EX |
|---|---|---|---|---|---|---|---|---|---|---|---|---|---|---|---|
| | 1 | 2 | 3 | 4 | 5 | EX1 | EX2 | EX3 | EX4 | EX5 | EX6 | EX7 | EX8 | 9 | 10 |
| Cycl 1 | 40 | | | | | 55 | 45.5 | 45.5 | 32.0 | | | | | | 45 |
| Cycl 2 | | | | 60 | | | | | | | 30 | 30 | | 30 | |
| Cycl 3 | | 46 | 50 | | 20 | | | | | 45.5 | | | 45 | | |
| Struct 1 | | | | 15 | | | 36.4 | 36.4 | | 36.4 | | 35 | 35 | | |
| Struct 2 | | 24 | | | | | | | 40.0 | | 40 | | | 40 | 40 |
| Struct 3 | | | | | | 21 | | | | | | | | | |
| Struct 4 | | | | | 40 | | | | | | | | | | |
| HPMA | | | 10 | 25 | | 15 | 18.2 | | 28.0 | 18.2 | 30 | 35 | 19 | | 15 |
| HEMA | | | | | | | | 18.2 | | | | | | | |
| IBOA | 20 | | | | | 9 | | | | | | | | 30 | |
| IBOMA | | | | | 20 | | | | | | | | | | |
| EHMA | | | | | 20 | | | | | | | | | | |
| Comp Cycl 7 | | | 20 | | | | | | | | | | | | |
| Comp UA | 40 | | | | | | | | | | | | | | |
| TMPTA | | | 20 | | | | | | | | | | | | |
| DPGDA | | 28 | | | | | | | | | | | | | |
| BAPO | 0.1 | 0.25 | 0.25 | 0.25 | 0.25 | 0.1 | 0.1 | 0.1 | 0.1 | 0.1 | 0.1 | 0.25 | 0.25 | 0.1 | 0.1 |
| MBF | 2.0 | | | | | 2.0 | 2.0 | 2.0 | 2.0 | 2.0 | 2.0 | | | 2.0 | 2.0 |
| HDMAP | | 1 | 1 | 1 | 0.25 | | | | | | | 1 | 1 | | |
| Total | 102.1 | 99.25 | 101.25 | 101.25 | 100.5 | 102.1 | 102.2 | 102.2 | 102.1 | 102.1 | 102.1 | 101.25 | 100.25 | 102.1 | 102.1 |
| Visco 25° C. | 360 | 395 | 280 | 770 | 450 | 530 | 1350 | 2280 | 1145 | 965 | 1740 | 890 | 915 | 2445 | 2215 |
| (mPa · s) | | | | | | | | | | | | | | | |

Table 2 provides an overview of different compositions made according to the invention (EX) and comparative compositions (Com).

### Results

TABLE 3
properties of the compositions after curing with UV (Ga lamp 120 W/cm (6000-7000 mJ/cm²))

| | Com | EX | EX | EX | EX | EX | EX | EX | EX | Com |
|---|---|---|---|---|---|---|---|---|---|---|
| | 1 | 1 | 2 | 3 | 4 | 5 | 6 | 9 | 10 | 5 |
| Ultimate flexural strain | 5 | 5 | 6.5 | 6.5 | >15 | 11 > 15 | 9 | 5 | 6.6 > 15 | |
| Ultimate elongation | 2.6 | 3.8 | 5.5 | 8.5 | 6 | 5.2 | 5.4 | 4.5 | 3.6 | |
| Tg1 = T(tan)max (° C.) | 130 | 125 | 113 | 106 | 97 | 113 | 127 | 131 | 116 | 75 |

Comparative example Com 1 is an example according to WO2014/191308, whereby the composition does not comprise a structural compound A which provides a composition that after curing has a poor ultimate elongation, which makes this composition not suitable for many composite applications.

Examples 1-6, 9 and 10 are compositions according to the invention and comprise a cyclic structure containing compound B, a structural containing compound A and a monomer C. They all have a high Tg, good to very good ultimate elongation and are very flexible. Especially a composition having the combination of a high Tg and a good ultimate elongation is not easy to obtain.

Comparative example Com 5 shows an example which is described in WO2019104079 whereby the composition comprises a high amount of a monoacrylate EHMA which has a Tg of its homopolymer of less than-10° C. This results in a composition that is not suitable for high thermal resistant composites as the Tg is only 75° C.

### Results UV Curing and Brine Analysis

TABLE 4
Characteristics of some compositions after UV curing for samples with and without contacting
with 28% NaCl solution at 80° C. during 10 days. Both have been evaluated after 10 days.

| | EX7 | | EX8 | | Com 2 | | Com 3 | | Com 4 | |
|---|---|---|---|---|---|---|---|---|---|---|
| | 10 d | 10 d 80° C. | 10 d | 10 d 80° C. | 10 d | 10 d 80° C. | 10 d | 10 d 80° C. | 10 d | 10 d 80° C. |
| | 23° | Brine | 23° | Brine | 23° | Brine | 23° | Brine | 23° | Brine |
| Tg (° C.) | 116 | 98 | 104 | 96 | 112 | 111 | 152 | 153 | 196 | 169 |
| Ultimate elongation (%) | 9.6 | 7.7 | 5.4 | 5.3 | 2.6 | 2.7 | 1.9 | X | 1.8 | X |
| Ultimate flexural strain (%) | 7.6 | 9.3 | 9.1 | 7.8 | 2.5 | 3.6 | 1.5 | 3.6 | 3.8 | 2.7 |

X means that the sample breaks into the clamps before test.

Table 4 shows that compositions according to the invention (EX 7 and EX 8) are able to maintain a high Tg, ultimate flexural strain and ultimate elongation even after contacting the cured composition in harsh conditions of 10 days brine, at elevated temperatures. Comparative example Com 4 has a too low amount of the structural compound A to provide good results.

Comparative examples Com 2 and Com 3 are diluted using a monomer having 2 or more acrylate groups. This provides a composition have a low performing resins with low ultimate elongation and/or ultimate flexural strain.

1. An actinic radiation curable and/or thermally curable composition (I) for composite material comprising:
(A) at least 20 wt % of compound A comprising at least 2 ethylenically unsaturated moieties and a structural moiety selected from the group consisting of polyalkylene glycol; polycaprolactone; polybutadiene or a hydrogenated or partially hydrogenated form thereof; polyisoprene or the hydrogenated or the partially hydrogenated form thereof; and/or polyester derivable from a polyol and a dicarboxylic acid;
(B) at least 20 wt % of compound B comprising at least 2 ethylenically unsaturated moieties and a cycloaliphatic structure or heterocyclic aliphatic structure;
(C) from 1 to 40 wt % of a compound C different from compound A and B containing essentially one ethylenically unsaturated moiety and having a viscosity of less than 100 mPa·s measured at 25° C., preferably below 50 mPa·s, even more preferably below 25 mPa·s; and
(D) from 0 to 20 wt % of a compound D, comprising at least one ethylenically unsaturated moiety, and which is different from compound A, B and C;
whereby the total of compound B and A have a content of from 60 to 99 wt % in view of the total content of compounds A, B, C and optionally D; and
wherein composition (I) has, after curing, a Tg of at least 90° C. according to the standard test method ASTM E1640 using dynamic mechanical analysis.

2. The curable composition (I) according to claim 1, whereby structural moiety of compound A derives from compounds having a Tg that is below 0° C., preferably below −20° C., more preferably below −30° C., even more preferably below −40° C.

3. The curable composition (I) according to claim 1, whereby the structural moiety of compound A is a polyester derivable from:
a condensation reaction of a straight chain aliphatic dicarboxylic acid having 4 to 14 carbon atoms and an aliphatic or cycloaliphatic polyol, preferably an aliphatic diol or cycloaliphatic diol;
a condensation reaction of a dimerized fatty acids compound with an aliphatic or cycloaliphatic diol; or
a condensation reaction of a dimerized fatty alcohols compound with an aliphatic diacid compound.

4. The curable composition (I) according to claim 1 whereby the structural moiety of compound A is:
a polyalkylene glycol moiety having the structure —((CH2nO)x- or —(CH2CH(CH3)O)x-; whereby n is an integer from 2 to 5 and x is an integer from 5 to 20
a polycaprolactone moiety having the structure —(C(C═O)(CH2)uO)t-; whereby u is an integer from 3 to 5 and t is an integer from 4 to 20;
a polybutadiene moiety having the structure —(CH2-CH(CH═CH2)p-(CH2-CH═CH—CH2)q-; whereby the sum of p and q is an integer from 10 to 100 and whereby p≥0 and q≥0; or a hydrogenated or partially hydrogenated form thereof;
a polyisoprene moiety having the structure —(CH2-C(CH3)═CH—CH2)r-, whereby r is an integer from 10 to 100, or a hydrogenated or partially hydrogenated form thereof; or
a polyester moiety having the structure —(O(C═O)—R′—(C═O)O—R″—)n-
whereby R′ is a saturated straight chain alkyl having 2 to 14 carbon atoms and R″ is a saturated aliphatic or cycloaliphatic alkyl; and whereby n is an integer from 3 to 20;
whereby R′ is a dimerized fatty acid residue; R″ is a saturated aliphatic or cycloaliphatic alkyl; and whereby n is an integer from 3 to 20; or
whereby R′ is an aliphatic diacid residue; R″ is a dimerized fatty diol residue; and whereby n is an integer from 3 to 20.

5. The curable composition (I) according to claim 1, wherein the weight average molecular weight of compound A is between 200 and 10000 more preferably between 400 and 5000.

6. The curable composition (I) according to claim 1, wherein compound A is polyester di- or tri-(meth)acrylate or polyurethane di- or tri-(meth)acrylate.

7. The curable composition (I) according to claim 1, wherein compound B comprises at least two ethylenically unsaturated moieties and preferably not more than 8, more preferably not more than 6 ethylenically unsaturated moieties.

8. The curable composition (I) according to claim 1, wherein compound B does not comprise the structural moiety of compound A.

9. The curable composition (I) according to claim 1, wherein composition (I) comprises
at least 20 wt % of compound A, and preferably from 20 wt % to 79 wt %, more preferably from 20 wt % to 40 wt % of compound A; and
at least 20 wt % of compound B, and preferably from 20 wt % to 79 wt %, more preferably from 20 wt % to 50 wt % of compound B; and
wherein the total of compound B and A have a content of from 60 to 99 wt % in view of the total content of compound A, B, C and optionally D.

10. The curable composition (I) according to claim 1 wherein compound C is added in an amount to obtain a viscosity of less than 2500,
preferably less than 1800, more preferably less than 1500 mPa·s when measured at 25° C.

11. The curable composition (I) according to claim 1, wherein the composition further comprises from 0.01 to 10 wt %, preferably from 0.1 to 8 wt %, more preferably from 0.1 to 5 wt % of a photoinitiator relative to the total weight of the composition.

12. The curable composition (I) according to claim 1, wherein the composition further comprises from 0.01 to 5 wt %, preferably from 0.1 to 4 wt %, more preferably from 0.2 to 3 wt % of a free-radical generating agent relative to the total weight of the composition.

13. The curable composition (I) according to claim 1, wherein the composition (I) has an ultimate tensile elongation of more than 3% as measured according to ASTM D638 and/or an ultimate flexural strain of more than 5% as measured according to the standard test method ASTM D790.

14. Composite material comprising the curable composition (I) according to claim 1 and a filler material (II).

15. Composite material comprising the curable composition (I) according to claim 14, wherein the filler material (II) is glass fiber, carbon fiber, synthetic polymer fiber, inorganic fiber, metal fiber, carbon nanotube, or mineral nanotube.

16. A process of making a composite material comprising the steps of:
contacting a filler material (II) with the curable composition (I) according to claim 1,
wherein the filler material (II) is glass fiber, carbon fiber, synthetic polymer fiber, inorganic fiber, metal fiber, carbon nanotube, or mineral nanotube; and
curing-the curable composition (I) in contact with the filler material (II).

17. Use of the curable composition (I) according to claim 1, for filament winding, with or without the presence of a liner, pultrusion, pull winding, mandrel wrapping, wet layup, resin transfer moulding, vacuum bagging, vacuum infusion, resin Infusion and the like.

18. Use of the curable composition (I) according to claim 1 for making conductive sleeves, such as glass fiber reinforced electrically conductive printing sleeves; whereby the curable composition (I) is contacted with electrically conductive nanoparticles, such as carbon nanotubes, before or during contacting with the filler material (II).
